(19) United States
(12) Patent Application Publication
(10) Pub. No.: US 2024/0052531 A1
(43) Pub. Date: Feb. 15, 2024

(54) METHOD AND APPARATUS FOR HEATING FIBER BUNDLE

(71) Applicants: KABUSHIKI KAISHA TOYOTA CHUO KENKYUSHO, Nagakute-shi (JP); TOYOTA JIDOSHA KABUSHIKI KAISHA, Toyota-shi (JP)

(72) Inventors: Yoshihide KATAGIRI, Nagakute-shi (JP); Takuya MORISHITA, Nagakute-shi (JP); Yuka YAMADA, Nagakute-shi (JP); Akira KUNITOMO, Toyota-shi (JP)

(73) Assignees: KABUSHIKI KAISHA TOYOTA CHUO KENKYUSHO, Nagakute-shi (JP); TOYOTA JIDOSHA KABUSHIKI KAISHA, Toyota-shi (JP)

(21) Appl. No.: 18/226,992

(22) Filed: Jul. 27, 2023

(30) Foreign Application Priority Data
Aug. 11, 2022 (JP) 2022-128544

(51) Int. Cl. D01F 9/22; D01F 9/32; C01B 32/205

(52) U.S. Cl. CPC D01F 9/22; D01F 9/328; C01B 32/205

(57) ABSTRACT

A method for a fiber bundle, including a heating process of Joule-heating the fiber bundle by energization between at least a pair of electrodes. The fiber bundle is carried in contact with the electrodes and has electrical conductivity at least between the electrodes. At least one of the electrodes has an aggregating structure that aggregates the fiber bundle while being in contact with the outer surface of fiber bundle. The aggregating structure has a trench or cylindrical shape with a structural surface that narrows in the depth direction. When the electrodes are each composed of a rotating body, the aggregating structure is a trench provided on the outer surface of the rotating body. The trench has a bottom surface that narrows toward a rotation center side. The trench may have a widened portion on the outer peripheral edge side. The widened portion guides the fiber bundle to the bottom surface.

### TECHNICAL FIELD

The present invention relates to a method for a fiber bundle and relevant techniques.

### BACKGROUND ART

Carbon fiber composite materials, which enable both the weight reduction and the high performance, are used not only in the aerospace field but also in a wide variety of products. Carbon fiber composite materials are usually composed of carbon fibers and matrices (such as resin, ceramics, and metal) that hold the carbon fibers. Common carbon fibers are fibers having a carbon content of 90% or more, and are obtained by firing organic fibers. There are a plurality of types of carbon fibers depending on the difference in raw materials. For example, there are PAN-based carbon fibers obtained from polyacrylonitrile (PAN) and pitch-based carbon fibers obtained from petroleum or coal pitch. Both types of carbon fibers are common in that they are obtained by stepwise heating organic fibers as the raw materials to high temperatures.

The heating process involved in the production of carbon fibers is generally performed by an indirect heating scheme that heats the fibers (bundle) in a furnace. However, high-temperature heating by the indirect heating scheme consumes a large amount of energy, so there has been proposed a direct heating scheme (in particular, a direct electric resistance heating scheme) that can save energy. The following documents describe relevant techniques to the direct electric resistance heating scheme.

### PRIOR ART DOCUMENTS

### Patent Documents

[Patent Document 1] JP Examined patent application publication No. S61-39411
[Patent Document 2] JP2015-214461
[Patent Document 3] U.S. Pat. No. 3,313,597

### Non-Patent Documents

[Non-Patent Document 1] TANSO, 146, pp. 8-14, 1991

### SUMMARY OF INVENTION

### Technical Problem

The direct electric resistance heating scheme enables continuous and efficient heating because the fibers (bundle) being carried are directly energized to Joule-heat the fibers themselves.

However, when the present inventors heated a moving fiber bundle by the conventional direct electric resistance heating scheme, the temperature fluctuation became large depending on the position of the fiber bundle, uniform heating was not possible, and high-performance carbon fibers were not able to be stably produced. None of the documents describes such problems, solutions, or the like.

The present invention has been made in view of such circumstances, and an object of the present invention is to provide a method and the like that can stably perform the heat treatment of a fiber bundle.

### Solution to Problem

As a result of intensive studies to achieve this object, the present inventors have succeeded in uniformly energizing and heating a moving fiber bundle by reviewing the shape of electrodes with which the fiber bundle is in contact.

Developing this achievement, the present inventors have accomplished the present invention, which will be described below.

### «Heating Method»

(1) The present invention provides a method, comprising moving a fiber bundle to length direction so that conductive surface of the fiber bundle is in contact with at least a pair of electrodes and heating the fiber bundle by applying a voltage between at least a pair of electrodes, wherein at least either electrode in the pair of electrodes has an aggregating structure that aggregates the fiber bundle while being in contact with an outer surface of the fiber bundle.

(2) According to the method for a fiber bundle of the present invention (simply referred to as “the method”), high-performance fibers (bundle) can be stably obtained even by the direct electric resistance heating scheme. This mechanism is currently inferred as follows.

The fiber bundle is in a state of being aggregated by the aggregating structure of the electrodes (a state in which fibers that constitute the fiber bundle are converged in close contact with each other). This allows the fiber bundle to maintain a state of stably contacting the electrodes (aggregating structure) over a wide area without fluttering even during the movement between the electrodes. It is considered that, as a result, not only the contact resistance between the fiber bundle and the electrodes, but also the contact resistance between the single fibers that constitute the fiber bundle is stably reduced, making it possible to almost uniformly heat the entire single fibers that constitute the fiber bundle.

Meanwhile, the fibers (bundle) that are subjected to direct electric resistance heating rather than indirect furnace heating are uniformly heated not only near the surface but also inside the fibers, and the structure (such as a carbonized structure) can become uniform as a whole. For example, the orientation, crystal formation, etc. of constituent elements (such as carbon) of single fibers can be in a form along the axial direction of the fibers that are energized. Such circumstances can contribute to the improvement of properties of the fibers according to the present invention.

### «Heating Apparatus»

The present invention is also perceived as a fiber heating apparatus. For example, the present invention may provide an apparatus comprising: at least a pair of electrodes; a conveying device configured to move a fiber bundle suspended between the pair of electrodes, to length direction of the fiber bundle; and a power source configured to supply electrical power to the pair of electrodes; wherein at least either electrode in the pair of electrodes has an aggregating structure that the fiber bundle while being in contact with an outer surface of the fiber bundle.

### «Fibers (Bundle)»

The present invention is also perceived as fibers (bundle) that are heat-treated using the above-described method or heating apparatus (referred to as “treated fibers (bundle)”). The fibers (bundle) before heating (referred to as “untreated fibers (bundle)”) to be supplied to the method or heating apparatus are not limited in the material or state, provided that the fibers have electrical conductivity between the electrodes that perform energization. The electrical conductivity is not limited in the specific electrical resistance or the like, provided that energization is possible.

### «Others»

(1) The “fiber bundle” as referred to in the present specification is an aggregate of “single fibers” (monofilaments). The number of filaments that constitute a typical fiber bundle is about 10 (0.01 k) to 240000 (240 k) in an embodiment or 100 (0.1 k) to 60000 (60 k) in another embodiment. In the present specification, the “fiber bundle” may also be simply referred to as “fibers” as appropriate. When clarifying the constituent elements of a fiber bundle, they may be referred to as single fibers or monofilaments.

(2) In conjunction with the use of the above-described electrodes, for example, energization control or the like between the electrodes may be performed based on the temperature of the fiber bundle measured between the electrodes. Specifically, in the heating process (step), the power supplied between the electrodes, the energization state between the fiber bundle and the electrodes, etc. may be controlled based on the temperature of the fiber bundle measured for at least one point between the electrodes.

(3) Unless otherwise stated, a numerical range “x to y” as referred to in the present specification includes the lower limit x and the upper limit y. Any numerical value included in various numerical values or numerical ranges described in the present specification may be selected or extracted as a new lower or upper limit, and any numerical range such as “a to b” can thereby be newly provided using such a new lower or upper limit. Unless otherwise stated, a range “x toy mm” as referred to in the present specification means x mm to y mm. The same applies to other unit systems.

### BRIEF DESCRIPTION OF DRAWINGS

FIG. 1 is a schematic diagram illustrating a heating apparatus;

FIG. 2 is a cross-sectional view illustrating an (open) trench provided on the outer peripheral surface of a roller (electrode I).

FIG. 3 is a cross-sectional view illustrating an (open) trench provided on the outer peripheral surface of a roller (electrode II).

FIG. 4 is a schematic plan view illustrating the temperature measurement positions of a fiber bundle during electric resistance heating.

FIG. 5 is a cross-sectional schematic diagram illustrating how the fiber bundle is aggregated in the trench (aggregating structure) of the roller (electrode I).

FIG. 6 is a flowchart illustrating an example of heating control.

### EMBODIMENTS FOR CARRYING OUT THE INVENTION

One or more features freely selected from the matters described in the present specification can be added to the above-described features of the present invention.

Features regarding a production method can also be features regarding a product. Which embodiment is the best or not is different in accordance with objectives, required performance, and other factors.

«Electrodes»

(1) At least one of the electrodes may have an aggregating structure that aggregates the fiber bundle while being in contact with the outer surface of the fiber bundle. Aggregation of the fiber bundle refers to a state in which the single fibers that constitute the fiber bundle are densely packed or further closely contacted with each other. When the fiber bundle passes through the aggregating structure from the upstream side to the downstream side, the cross section (the cross section formed by the envelope of the outer periphery) usually changes in accordance with the cross section of the aggregating structure and is reduced in the shape in dependence on the density of the single fibers.

Various forms of such an aggregating structure are conceivable. For example, the aggregating structure is either cylindrical-shaped or a trench (or (open) groove) with a decreasing width to depth direction. The cross-sectional shape of the aggregating structure is, for example, an arc shape, a V shape, a U shape, an annular shape, or the like. The number of aggregating structures per electrode may be one or two or more. A plurality of trenches or tubes may be considered as one aggregating structure.

The depth (h), width (W), etc. of the aggregating structure are appropriately adjusted in accordance with the size of the fiber bundle (single fiber diameter×number of fibers, or the like). With reference to a thickness (t) from the lowest point (deepest bottom point) of the aggregating structure to the upper surface (surface opposite to the bottom) of the fiber bundle, h/t may be, for example, 1 to 10 in an embodiment, 2 to 8 in another embodiment, or 3 to 5 in still another embodiment. W/t may be, for example, 0.05 to 20 in an embodiment, 0.1 to 10 in another embodiment, 0.2 to 8 in still another embodiment, or 2 to 6 in yet another embodiment. W is, for example, the maximum trench width (distance between inner edges on the outer surface side) in the case of an open groove-shaped aggregating structure, or the maximum inner peripheral width in the case of a cylindrical-shaped aggregating structure. h is, for example, the height (shortest distance) from the measured level of W to the deepest bottom point. In particular, when the bottom portion of the aggregating structure has an arcuate cross section, its radius of curvature (r) may be such that r/t is, for example, 0.025 to 10 in an embodiment, 0.05 to 5 in another embodiment, 0.1 to 4 in still another embodiment, or 1 to 3 in yet another embodiment. In this case, for example, h>r or W>2r may be established, or h=r(h=r) or W=2r (W=2r) may be established.

The electrodes may be rotating bodies (such as rollers and rotors) or sliding bodies. The aggregating structure is an (open) trench located in outer surface of the rotating body and width of the trench decreases to rotational axis direction of the rotating body. The trench has a sloping part in outer surface side. Additionally or alternatively, the trench may have side walls that merge into the outer surface side from the bottom surface in order to prevent deviation of the fiber bundle.

When provided on a non-rotating body, the aggregating structure may be, for example, any of an (open) trench and a penetrating tube. The penetrating tube may have an enlarged diameter portion (e.g., a tapered portion or the like) on the upstream edge side. The enlarged diameter portion guides the fiber bundle.

The aggregating structure may be provided on at least one electrode (in particular, the upstream electrode), but may also be provided on each of a plurality of electrodes with which the fiber bundle is in contact. For example, both the upstream electrode and the downstream electrode may be provided with aggregating structures. Additionally or alternatively, an electrode in between them (intermediate electrode) may be provided with an aggregating structure. Additionally or alternatively, a trench-shaped aggregating structure and a cylindrical-shaped aggregating structure may coexist in a pathway for the fiber bundle. For example, a rotating electrode having an (open) trench (first aggregating structure) and a non-rotating electrode having a penetrating tube (second aggregating structure) may coexist in a pathway for the fiber bundle.

(2) The electrodes come into contact with the fibers (bundle) that reach a high temperature and may therefore be made of a conductive material that is excellent in the heat resistance and the abrasion resistance. Examples of such conductive materials include graphite, metals, and ceramics.

The electrode surface that comes into contact with the fibers (including the structural surface of the aggregating structure) may be smoothed for reduction of the contact resistance, stabilization of the energization, etc. Its surface roughness (Rzjis) may be, for example, 12.5 μm or less in an embodiment, 6.3 μm or less in another embodiment, or 3.2 μm or less in still another embodiment. Suffice it to say that the lower limit may be 0.01 μm or more in an embodiment or 0.1 μm or more in another embodiment.

The material or form of the electrodes on the upstream side (fiber bundle feeding side) and the downstream side (fiber bundle recovery side) may be the same or different. The use of the same electrodes facilitates the component management and the like.

At least a pair of electrodes (two electrodes) may be sufficient, but there may be three or more electrodes or two or more pairs. The number of electrodes to be arranged may be determined in accordance with the number of energization sections (between electrodes) to be arranged, the wiring method, etc. When providing a plurality of energization sections, the energization conditions (such as supplied power, heating time, and contact state) may be changed between the energization sections. The target temperature of the fiber bundle may be changed for each energization section, or the energization conditions may be optimized in accordance with changes in the fiber bundle (such as changes in resistance value and form).

### «Power Source»

The power source may be an AC power source or a DC power source. The use of a stabilized power source facilitates the control of current and/or voltage (e.g., feedback control).

### «Moving (Carriage)»

For carrying the fiber bundle, for example, a winding body (such as bobbin or roller) provided at least on the downstream side may be driven by a motor or the like to wind the fiber bundle. The conveying device (carrying means) composed of a winding body and a drive source may be provided not only on the downstream side but also on the upstream side.

The moving speed of the fiber bundle (e.g., the carrying speed) may be constant, or may be changed in accordance with the energization state. When the drive source is a motor, the moving speed can be adjusted by controlling the number of rotations. The moving speed may be adjusted to stabilize or improve the contact state (energization state) between the fiber bundle and the electrodes (aggregating structure), the contact state and/or the rotational movement state between the electrodes (such as rollers) and the rotating shafts, the productivity (heat treatment speed), etc. The “movement” as referred to in the present specification includes relative movement of the fibers with respect to the electrodes.

«Distance between Electrodes»

The distance between the electrodes may be constant or may also be changed in accordance with the energization state. For example, the distance between the electrodes may be shortened to allow the temperature of the fiber bundle to rise easily. The distance between the electrodes may be changed in accordance with the moving speed of the fiber bundle. By adjusting the distance between the electrodes in accordance with the moving speed, for example, the heating time (energization time) for the fiber bundle by energization may be controlled. The distance adjusting device (means) for the distance between the electrodes can be achieved, for example, by a slider that can move at least one electrode to a predetermined position. The slider is composed, for example, of a drive source (such as a servomotor), a linear guide, a ball screw, etc.

### «Tension»

The tension of the fibers (bundle) suspended between the electrodes may be constant or may also be changed in accordance with the energization state. The tension is adjusted, for example, by a tensioner. The tensioner applies a desired load to the fiber bundle, for example, via idlers, rollers, sliders, etc. that are in contact with the fiber bundle. The load source is, for example, electromagnetic force (such as motor or solenoid), hydraulic pressure, pneumatic pressure, gravity (weight), spring, or the like. The rollers are not particularly limited, but examples thereof include a nip roller, a feed roller composed of a plurality of rollers, and the like. The above-described conveying device or the like may also serve as the tensioner. For example, the rotational torque of winding bodies provided downstream and/or upstream the fiber bundle may be changed by a motor or the like to adjust the tension of the fiber bundle, or the winding speed on the downstream side and the feeding speed on the upstream side of the fiber bundle may be adjusted to adjust the tension in accordance with the speed difference.

When there are three or more electrodes, the tension between each pair of electrodes may be adjusted collectively or may also be adjusted individually. By adjusting the tension, the contact state (energization state) between the fiber bundle and the electrodes can be stabilized. The tension is, of course, adjusted within a range in which the moving fiber bundle does not loosen or break.

The tension adjusting device (tensioner) is composed, for example, of a contact body (such as a rotating body or a sliding body) that is in contact with the fiber bundle and a mechanism that moves the contact body to a predetermined position and holds it. The material of the contact body is not limited, but the contact body may be preferably made of a material (e.g., graphite) having the heat resistance, durability, etc. like the electrodes.

The tension applied to the fiber bundle during the carriage may be, for example, 0.1 to 100 (×10⁻³ N/tex) in an embodiment, 0.2 to 50(×10⁻³ N/tex) in another embodiment, or 1 to 25 (×10⁻³ N/tex) in still another embodiment. The “tex” represents the SI unit indicating weight (g) per 1000 m of length. For example, when a load (weight) of 100 g (0.1 kgf=0.98 N) is applied to a representative fiber bundle of 800 tex, the tension acting on the fiber bundle is 1.225×10⁻³ N/tex (=0.98 N/800 tex).

### «Temperature»

The temperature of the fibers (bundle) during the electric resistance heating may be measured continuously or discretely (intermittently). The measuring device is not limited (such as in the form or type of thermometer). The temperature of fibers (bundle) that are thin and have small heat capacity, strength, or the like can be accurately measured, for example, by a non-contact thermometer (such as radiation thermometer or thermography).

### «Control»

The heating control of the fiber bundle may be performed based on the temperature of the fiber bundle measured for at least one point. The control scheme is not limited (such as feedback control or feedforward control). For example, feedback control based on the measured temperature of the fiber bundle (simply referred to as an “actual temperature”) may be performed in real time to stably converge the actual temperature of the fiber bundle to a target temperature. The temperature difference between the target temperature and the actual temperature (fluctuation range) varies depending on the type of fiber bundle, the purpose of heating, the spec of the apparatus (device), etc., but may preferably fall, for example, within +75° C. or ±50° C.

Control objects include, for example, the amount of energization (supplied power) between the electrodes, the energization state of the fiber bundle and the electrodes (such as the tension applied to the fiber bundle suspended between the electrodes or the moving speed of the fiber bundle between the electrodes). Control of the amount of energization, which is a representative example, may be performed by changing either one of the current and the voltage or by changing both.

The moving speed of the fiber bundle also affects the heating time. When the heating time falls within a predetermined range, the distance between the electrodes may be adjusted in accordance with the moving speed.

### «Atmosphere»

The fiber bundle may be preferably heated in an atmosphere suitable for the purpose of treatment. Heating under an oxidizing atmosphere may be performed in the air (open state). For heating under a non-oxidizing atmosphere, a chamber may be used in which at least the fiber bundle between the electrodes is in a desired atmosphere.

The non-oxidizing atmosphere as referred to in the present specification includes not only an inert gas atmosphere (such as rare gas atmosphere or nitrogen gas atmosphere) but also a vacuum atmosphere. When a part of components of the untreated fiber is released as gas due to heating, the electric resistance heating may be preferably performed under a gas flow atmosphere or an exhaust atmosphere.

### «Fibers (Bundle)»

(1) Fibers before electric resistance heating treatment (untreated fibers) may be composed of any of organic fibers, inorganic fibers, metal fibers, etc., regardless of the material, provided that the heating by energization is possible. Typical examples include stabilized fibers, infusibilized fibers, pre-carbonized fibers, carbon fibers, and graphitized fibers.

Original organic fibers, such as those that have been reeled or spun, normally have high electrical resistance and low electrical conductivity. Such organic fibers may be preferably subjected to a pretreatment to impart the electrical conductivity at least before passing through the upstream electrode. For example, under an oxidizing atmosphere (usually under an air atmosphere), PAN-based organic fibers can be heated (stabilized), for example, at 200° C. to 400° C. to obtain stabilized fibers, and pitch-based organic fibers can be heated (infusibilized), for example, at 200° C. to 400° C. to obtain infusibilized fibers. The electrical conductivity of stabilized fibers, infusibilized fibers, etc. increases as the heating temperature rises, and in particular, when heated to 250° C. or higher, preferably 300° C. or higher, it can exhibit electrical conductivity suitable for the electric resistance heating. Pre-carbonized fibers can be obtained by heating (pre-carbonizing) stabilized fibers, infusibilized fibers, etc. in an inert atmosphere (such as inert gas atmosphere or vacuum atmosphere), for example, at 400° C. to 1000° C. In the present specification, the pre-carbonized fibers (bundle) as well as the stabilized fibers (bundle), infusibilized fibers (bundle), etc., are referred to as untreated fibers (bundle). Organic fibers that contain additives (dispersing agents) such as conductive fillers can also be used as the untreated fibers (bundle).

Carbon fibers, graphitized fibers, etc. can be obtained by electric resistance heating of the untreated fibers. Carbon fibers can be obtained, for example, by heating stabilized fibers, infusibilized fibers, or pre-carbonized fibers at 1000° C. to 2000° C. in an inert atmosphere (carbonization process). Graphitized fibers can be obtained, for example, by heating carbon fibers at 2000° C. to 3000° C. in an inert atmosphere (graphitization process).

(2) If the untreated fibers (bundle) have few fluffs, twists, or the like and are shaped, the contact state (contact resistance) with the electrodes (aggregating structure) can be stabilized. The untreated fibers may be subjected to surface treatment such as sizing. The treated fibers (bundle) may also be subjected to surface treatment such as sizing after heating.

Examples of the organic fibers to be raw materials for the untreated fibers include not only the PAN-based fibers and the pitch-based fibers but also polyacrylamide-based fibers, phenol resin-based fibers, polyvinyl alcohol-based fibers, polyolefin-based fibers, diene-based polymer fibers, regenerated cellulose-based fibers, and lignin-based fibers. The treated fibers obtained by energizing and heating the untreated fibers may be those in which the component composition is changed with respect to the untreated fibers or those in which only the structure is changed.

### EXAMPLES

The present invention will be described in more detail while illustrating specific examples of the heating apparatus and method for a fiber bundle.

### «Heating Apparatus»

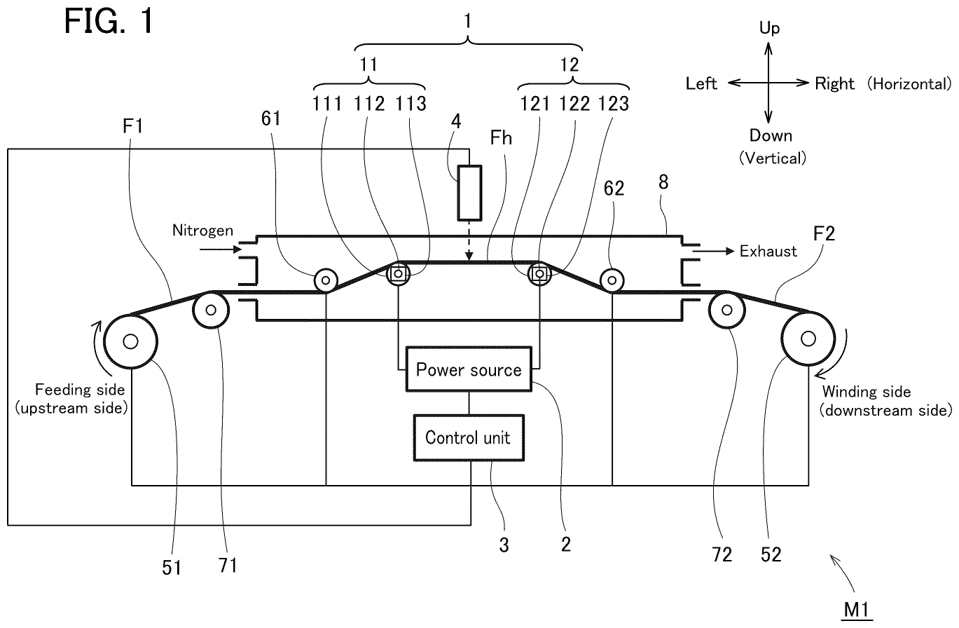

FIG. 1 illustrates a heating apparatus M1 for a fiber bundle (simply referred to as an “apparatus M1”), which is an embodiment of the present invention. The right-left direction (horizontal direction) and the up-down direction (vertical direction) referred to in this example are the directions of arrows illustrated in FIG. 1.

### (1) Overview

The apparatus M1 includes a pair of rollers 11 and 12, a power source 2, a control unit 3 (control device) composed of a computer, a radiation thermometer 4, a feeding bobbin 51 for an untreated fiber bundle F1 and a winding bobbin 52 for a treated fiber bundle F2 (conveying device), tensioners 61 and 62, idlers 71 and 72 (idling bodies/idle wheels) that guide and support the untreated fiber bundle F1 on the feeding side and the treated fiber bundle F2 on the winding side, respectively, and a chamber 8 that creates a predetermined atmosphere around an electric resistance heating fiber bundle Fh.

The rollers 11 and 12 (both collectively referred to as “rollers 1”) are composed of graphite cylindrical bodies 111 and 121 (electrodes) that are pivotally supported on graphite rotating shafts 112 and 122, respectively. The power source 2 is connected to terminals 113 and 123 provided at axial ends of the rotating shafts 112 and 122, respectively. Electric power is supplied to the cylindrical bodies 111 and 121 from the terminals 113 and 123 through the rotating shafts 112 and 122. The space between the cylindrical body 111 and the cylindrical body 121 (between the electrodes) will be referred to as “between the cylindrical bodies” or “between the rollers” as appropriate.

The distance between the roller 11 (cylindrical body 111) and the roller 12 (cylindrical body 121) (inter-electrode distance) can be adjusted by using a slider (not illustrated/distance adjusting device). The slider is composed, for example, of a linear guide, a ball screw, a servo motor, etc. The ball screw is driven by a servomotor controlled by the control unit 3 to move at least one of the rollers 11 and 12 along the linear guide extending in the right-left direction and stop the at least one of the rollers 11 and 12 at a desired position. The distance between the rollers 11 and 12 can thus be adjusted.

The power source 2 is composed of a DC stabilized power source, and the output (voltage and/or current) is controlled by the control unit 3. This adjusts the amount of energization (supplied power) between the cylindrical bodies.

The feeding bobbin 51 and the winding bobbin 52 (both simply referred to as “bobbins 5”) are each driven by a motor (not illustrated). Each motor is controlled (e.g., synchronized control) by the control unit 3 to adjust the moving speed of the untreated fiber bundle F1, the electric resistance heating fiber bundle Fh, and the treated fiber bundle F2 (these will be collectively referred to as a “fiber bundle F”).

The tensioners 61 and 62 (both collectively referred to as “tensioners 6”) are provided on the feeding side (upstream side) and the winding side (downstream side), respectively, and apply a tension to the electric resistance heating fiber bundle Fh suspended between the cylindrical bodies 111 and 121. The tensioners 61 and 62 are driven by respective motors (not illustrated) and can move in the up-down direction. Each motor is synchronously controlled by the control unit 3 to vary the downward pressing force for the untreated fiber bundle F1 and the downward pressing force for the treated fiber bundle F2. Thus, the tensioners 6 adjust the tension of the electric resistance heating fiber bundle Fh.

The chamber 8 is a container body provided with a gas inlet and a gas outlet and its inside can be made to a desired atmosphere. For example, an inert gas (e.g., nitrogen gas) is introduced from the upstream inlet and exhausted from the downstream outlet. This allows the inside of the chamber 8 to be a stable inert gas atmosphere even when gas is generated from the electric resistance heating fiber bundle Fh.

Another roller may be added between the rollers 11 and 12 to provide a plurality of energization sections (between electrodes). In this case, the heating condition may be individually set for each energization section. For example, the fiber bundle may be heated stepwise by changing the target temperature or the supplied power in each energization section.

### (2) Rollers (Electrodes)

Trenches 115 and 125 were formed on the outer peripheral sides of the cylindrical bodies 111 and 121 of the rollers 11 and 12 constituting the electrodes. The rollers 11 and 12 were set to have the same shape and the trenches 115 and 125 were also set to have the same shape. The trench 115 of the roller 11 will be described herein in detail.

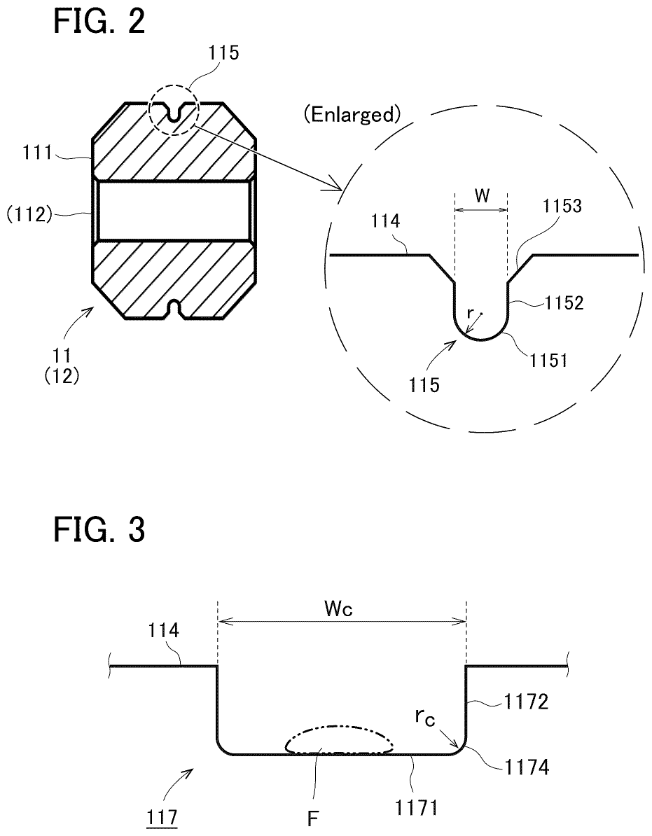

As illustrated in FIG. 2, the trench 115 is a narrow annular (open) trench formed near the center of the outer peripheral surface of the cylindrical body 111. The trench 115 has a bottom portion 1151 (aggregating structure) having a semicircular cross section on the rotation center side of the roller 11, wall portions 1152 extending parallel to the radial direction of the roller 11 from both end edges of the bottom portion 1151, and guide portions 1153 (widened portions) that are tapered from both edges of the wall portions 1152 and merge into outer peripheral surfaces 114 of the roller 11.

In this example, the radius of curvature of the bottom portion 1151 is r, the trench width, which is the distance between the wall portions 1152, is W (=2r), and the electrode (roller) having such a trench shape is referred to as an “electrode I.”

For comparison, rollers 11 and 12 provided with trenches 117 and 127 having a different shape from that of the trenches 115 and 125 were also prepared. The trenches 117 and 127 have the same shape, so only the trench 117 will be described.

As illustrated in FIG. 3, the trench 117 is a wide annular (open) trench formed near the center of the outer peripheral surface of the cylindrical body 111. The trench 117 has a bottom portion 1171 (aggregating structure) having a rectangular cross section (flat shape) on the rotation center side of the roller 11 and wall portions 1172 extending parallel to the radial direction of the roller 11 from both end edges of the bottom portion 1171. The bottom portion 1171 and the wall portions 1172 are connected by corner portions 1174.

In this example, the trench width, which is the distance between the wall portions 1172, is Wc, the radius of curvature of the corner portions 1174 is rc, and the electrode (roller) having a trench shape whose trench width We is sufficiently larger than the outer diameter of the untreated fiber bundle F1 or the treated fiber bundle F2 is referred to as an “electrode II.”

### «Production of Samples»

Using the above-described heating apparatus, treated fiber bundles were actually produced by heat-treating untreated fiber bundles, and their properties were evaluated. Specifically, it is as follows.

### <Untreated Fiber Bundle>

Pre-carbonized fiber bundles produced as follows were used as untreated fiber bundles.

(1) A polyacrylonitrile-based fiber bundle (number of fibers: 3000/bundle, fineness of fiber bundle: 360 tex/bundle, fineness of single fiber: 0.12 tex/fiber, fiber diameter of single fiber: about 11 μm) was prepared as a raw material fiber bundle.

The raw material fiber bundle was moved in a heating furnace with a temperature gradient (temperature increase) from 200° C. to 300° C. under an air flow for 48 minutes stabilizing treatment process). Thus, a stabilized fiber bundle (number of fibers: 3000/bundle, fineness of fiber bundle: 330 tex/bundle, fineness of single fiber: 0.11 tex/fiber, fiber diameter of single fiber: about 10 μm) was produced.

The stabilized fiber bundle was moved in a heating furnace with a temperature gradient (temperature increase) from 300° C. to 1000° C. under a nitrogen gas flow for 3 minutes (pre-carbonization process). Thus, a pre-carbonized fiber bundle (number of fibers: 3000/bundle, fineness of fiber bundle: 180 tex/bundle, fineness of single fiber: 0.06 tex/fiber, fiber diameter of single fiber: about 7 μm) was produced. The pre-carbonized fiber bundle (fiber bundle width: about 2 mm) is referred to as an “untreated fiber bundle α.”

(2) In addition, the above-described stabilized fiber bundle was moved in a heating furnace with a temperature gradient (temperature increase) from 300° C. to 800° C. under a nitrogen flow for 3 minutes. Thus, a pre-carbonized fiber bundle (number of fibers: 3000/bundle, fineness of fiber bundle: 220 tex/bundle, fineness of single fiber: 0.07 tex/fiber, fiber diameter of single fiber: about 8 μm) was also produced. The pre-carbonized fiber bundle (fiber bundle width: about 2 mm) is referred to as an “untreated fiber bundle.”

### <Electric Resistance Heating>

Each untreated fiber bundle (pre-carbonized fiber bundle) was energized and heated using the apparatus M1 to produce a treated fiber bundle. Specifically, it is as follows.

### (1) Conditions

Nitrogen gas was introduced into the chamber 8 to create an inert atmosphere with an oxygen concentration of less than 10 ppm in the chamber 8. The carrying speed of the fiber bundle F was set to 12 mm/min, the tension of the fiber bundle F was set to 191 gf (7.8×10⁻³ N/tex), the distance between the electrodes to be energized was set to 35 mm (passage time between the rollers 11 and 12: 2 minutes 55 seconds), and the energization time was set to 10 minutes. In this operation, the heating temperature of the fiber bundle F was set to 1400° C. (target temperature), and the fiber bundle F was energized and heated by constant current control with a current value of 5 A (constant).

### (2) Treatment

The untreated fiber bundle α or the untreated fiber bundle β was energized and heated using the apparatus M1 equipped with the electrodes I (r=0.5 mm, W=1 mm) or the electrodes II (rc=0.5 mm, Wc=6 mm). Through this operation, the treated fiber bundles F2 (carbon fiber bundles) of Samples 1, 2, and C1 listed in Table 1 were obtained. The depth from the outer peripheral surfaces 114 of the electrodes I to the deepest portions was 1.5 mm, and the depth from the outer peripheral surfaces 114 of the electrodes II to the bottom portions 1171 was 1.5 mm.

### (3) Measurement

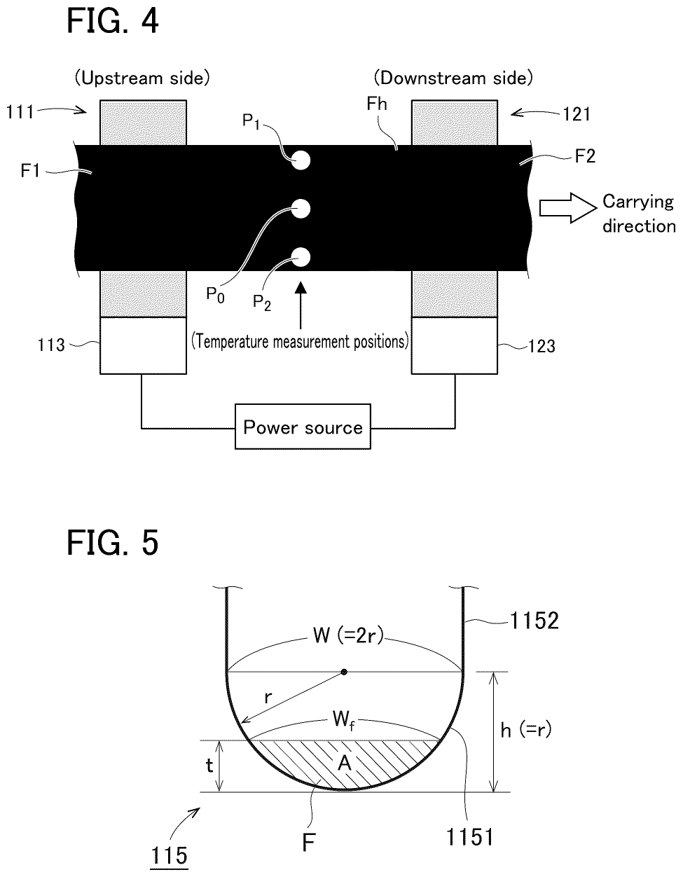

During the electric resistance heating, the resistance value between the electrodes (between the rollers 11 and 12) and the surface temperature of the electric resistance heating fiber bundle Fh were measured. The resistance value was obtained by dividing the voltage value measured with the power source device by the current value. The temperature was measured from above the electric resistance heating fiber bundle Fh by using the radiation thermometer 4. As illustrated in FIG. 4, the measurement positions were approximately near the center between the electrodes and the measurement was performed at three locations in the width direction of the electric resistance heating fiber bundle Fh (central portion: P0, one end portion: P1, and other end portion: P2).

Table 1 also lists the resistance value and surface temperature measured during the electric resistance heating for each sample. The average value listed in the table is an arithmetic mean value (N=5) of the measured values every 0.5 milliseconds. The variation width is an error (fluctuation) of each measured value with respect to the average value. The surface temperatures of the end portions P1 and P2 listed in Table 1 are errors (fluctuations) of the average values of the end portions P1 and P2 with respect to the average value of the central portion P0.

### <Furnace Heating>

For comparison, the above-described pre-carbonized fiber bundle was heated using a conventional carbonization furnace (electric furnace) to produce a treated fiber bundle. Specifically, it is as follows.

The atmosphere in the furnace and the tension of the fiber bundle F were set to the same as those in the case of the electric resistance heating, and the untreated fiber bundle α or the untreated fiber bundle β was subjected to furnace heating at 1400° C. for 3 minutes. Thus, treated fiber bundles F2 (carbon fiber bundles) of Samples D1 and D2 listed in Table 1 were obtained.

### <Measurement>

A tensile test was performed on each of five single fibers randomly taken out from the treated fiber bundle F2 of each sample, and the tensile strength and the tensile modulus were measured. Table 1 also lists the arithmetic mean values (N=5) of the measured values. For Sample C1, the upper limit is listed using an inequality sign (<) because the fluctuation of the measured values was large.

The tensile test was performed at room temperature using a microstrength evaluation tester (Micro Autograph MST-I available from Shimadzu Corporation) in accordance with JIS R 7606. In this test, the distance between gauge length was set to 25 mm, and the tensile speed was set to 1 mm/min.

The size of a single fiber (referred to as a “fiber diameter”) was measured using a microscope (Digital Microscope VHX-1000 available from Keyence Corporation). Specifically, for each of ten single fibers randomly taken out from the fiber bundle F of each sample, the fiber diameter (width) is measured at four randomly selected locations. The arithmetic mean value of these was adopted as the fiber diameter of the single fiber of each sample. The cross section of each single fiber was circular with the diameter of the fiber.

### «Evaluation»

(1) As apparent from Table 1, in the case of Samples 1 and 2 in which the untreated fiber bundles F1 were energized and heated using the rollers 11 and 12 (electrodes I) provided with the trenches 115, high-strength and high-rigidity carbon fibers were stably obtained. Moreover, in the case of Samples 1 and 2, the energization state (change in the resistance value) during the electric resistance heating and the surface temperature of the electric resistance heating fiber bundle Fh were also stable. These are considered to be because the trenches 115 allowed the untreated fiber bundle F1 to be energized and heated in a dense state.

On the other hand, in the case of Sample C1 in which the untreated fiber bundle F1 was energized and heated using the rollers 11 and 12 (electrodes II) provided with the trenches 117, as listed in Table 1, the strength and rigidity of the carbon fibers were insufficient. Moreover, in the case of Sample C1, the energization state (change in the resistance value) during the electric resistance heating and the surface temperature of the electric resistance heating fiber bundle Fh fluctuated greatly. This is considered to be because the fiber bundle F was not aggregated in the trenches 117 and moved in the bottom portions 1171 in a planarly spread state.

(2) In Samples 1 and 2 which were energized and heated using the electrodes I, carbon fibers (bundles) having higher properties were obtained than Samples D1 and D2 which were heated in a furnace as in the prior art. On the other hand, in Sample C1 which was energized and heated using the electrodes II, the properties of the carbon fibers (bundle) were lower than those of Samples D1 and D2.

(3) FIG. 5 schematically illustrates the situation in which the fiber bundle F moves in the trench 115 (electrode I). The bottom portion 1151 of the trench 115 is composed of a structural surface having an arcuate cross-section that narrows as it becomes deeper. Therefore, the fiber bundle F is aggregated along the bottom portion 1151 into a state in which the single fibers constituting the fiber bundle F are densely packed.

In the case of Samples 1 and 2, the untreated fiber bundle F1 has a cross-sectional area A of 0.12 mm², the bottom portion 1151 (semicircular portion: W=1 mm, r=0.5 mm) has a cross-sectional area of 0.39 mm², and a thickness t from the deepest position of the untreated fiber bundle F1 is 0.21 mm. In this case, r/t=2.38 and W/t=4.76 are established.

As described above, according to the present invention, uniform heating is possible even with the electric resistance heating scheme, and fibers (bundles) having high properties can be stably obtained.

### «Supplementary»

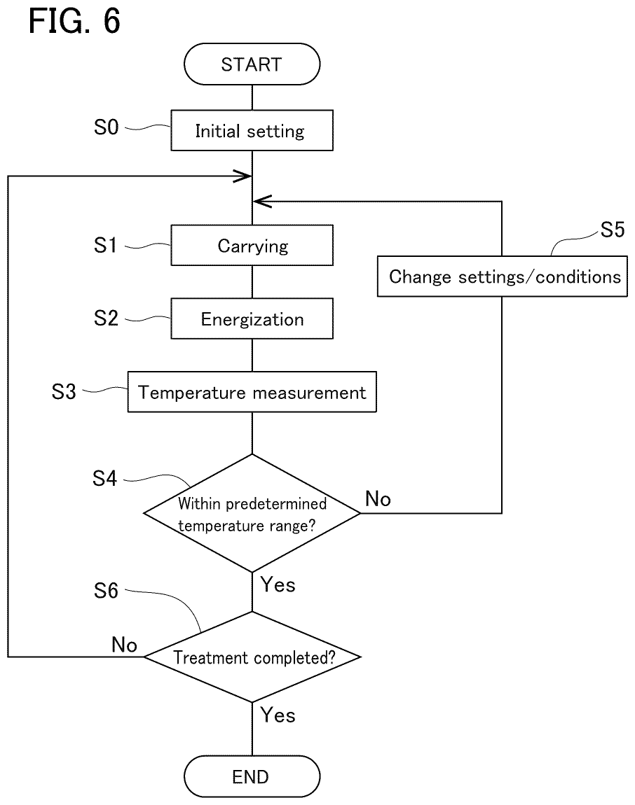

FIG. 6 illustrates a processing example (procedure/steps) for heat-treating the untreated fiber bundle F1 using the above-described apparatus M1. The following steps may be performed together with the electric resistance heating using electrodes having aggregating structures.

In step S0, the initial setting of the conditions and the like required for the heat treatment of the untreated fiber bundle F1 is performed. Setting items include, for example, a target temperature (To) of the electric resistance heating fiber bundle Fh during the electric resistance heating, the tolerance of an actual temperature (T) with respect to the target temperature (ΔT=|T⁻To|), the heating time for the electric resistance heating fiber bundle Fh (tm: passing time between rollers), the distance between rollers (L: distance between electrodes), the carrying speed of the fiber bundle F (V: moving speed), a tension (S) of the electric resistance heating fiber bundle Fh, and the amount of energization between rollers (voltage (E)·current (I) or power (Q)), etc. The initial value of each setting item (variable) is indicated with the suffix “o” as appropriate.

The heating time (tm) is obtained from the distance (L) between the rollers and the carrying speed (V) of the fiber bundle F (tm=LV). In the case of electric resistance heating with an approximately constant heating time, it is preferred to change L and V in a coordinated manner. If there is a positive correlation between the actual temperature (T) of the electric resistance heating fiber bundle Fh and the amount of energization (Q=E·I), the setting of the initial voltage (Eo) and the initial current (Io) or the initial power (Wo) will be easy in accordance with the target temperature (To).

In step S1, the control unit 3 operates or sets the bobbins 5, the slider for the rollers 1, the tensioners 6, etc. based on the initially set Vo, Lo, So, etc., and starts (or continues) carrying the fiber bundle F.

In step S2, the control unit 3 starts (or continues) energizing the rollers 1 from the power source 2 based on the initially set Qo (=Eo·Io) and starts (or continues) Joule-heating the electric resistance heating fiber bundle Fh between the rollers. The sequences of starting step S1 and step S2 may be reversed or may also be approximately simultaneous.

In step S3, the control unit 3 uses the radiation thermometer 4 to measure the temperature of the electric resistance heating fiber bundle Fh between the rollers. After the start of energization in step S2, the temperature measurement may be started after the time (initial transition time) for the temperature of the electric resistance heating fiber bundle Fh to stabilize elapses. The temperature of electric resistance heating fiber bundle Fh is normally raised to near the target temperature within a very short time after the energization is started.

In step S4, the control unit 3 determines whether or not the measured actual temperature of the electric resistance heating fiber bundle Fh falls within a predetermined temperature range with respect to the target temperature (e.g., |T⁻To|≤ΔT).

When the actual temperature falls outside the temperature range, in step S5, the control unit 3 controls the power source 2, the tensioners 6, or the bobbins 5 to change one or more settings/conditions of the amount of energization (E, I, or Q), the tension (S), and the carrying speed (V). For example, when the actual temperature of the electric resistance heating fiber bundle Fh is low, the power source 2 is controlled to increase the amount of energization. Additionally or alternatively, when the fluctuation of the actual temperature is large, the tensioners 6 and/or the bobbins 5 are controlled to increase or decrease the tension and/or increase or decrease the carrying speed. This improves the contact state between the electric resistance heating fiber bundle Fh and the surfaces of the rollers 1, the contact state between the cylindrical bodies 111 and 121 and the rotating shafts 112 and 122, etc. to stabilize the contact resistances between them, and the fluctuation of the actual temperature can be suppressed. When it is necessary to keep the heating time of the electric resistance heating fiber bundle Fh constant, the control unit 3 may control the slider (not illustrated) to shorten the distance between the rollers as the carrying speed decreases, or extend the distance as the carrying speed increases.

When the actual temperature falls within the predetermined temperature range in step S4, the control unit 3 continues the electric resistance heating and carrying of the fiber bundle F under the same settings/conditions (step S6). This treatment is continued until the electric resistance heating of a desired amount of the untreated fiber bundle F1 is finished. For example, this treatment is continued until the untreated fiber bundle F1 wound around the feeding bobbin 51 is wound up as the treated fiber bundle F2 onto the winding bobbin 52 (step S6). Of course, the treatment may be continued within a desired range while (semi)automatically or manually switching the bobbin 52 to the next bobbin when the winding on the bobbin 52 is finished.

If the actual temperature fluctuates beyond the predetermined range (step S4) during the treatment (during the circulation processing loop: steps S6→S1→S2→S3→S4→S6), the settings/conditions are reviewed (step S5), and the processing loop from step S1 to step S6 is repeated. Thus, the feedback control based on the actual temperature of the electric resistance heating fiber bundle Fh is performed in real time, and the treated fiber bundle F2 heated at the desired temperature is obtained for the desired amount of the untreated fiber bundle F1.

In this manner, the heat treatment of the fiber bundle F may be made more stable. The combination, priority, etc. of the control items for which the settings are changed in step S5 described above may be determined in accordance with the type of the fiber bundle F, changing situation of the actual temperature, etc.

In the present specification, the “means” and “process or step” can be substituted with each other. For example, a “-means” as substitute for a “-process or -step” may be a feature of a “product” (such as a heating apparatus), and a “-process or -step” as substitute for a “-means” may be a feature of a “method” (such as a heating method).

TABLE 1

| | | | | Heating situation | | | | | | | |
|---|---|---|---|---|---|---|---|---|---|---|---|
| | | | | | | Surface temperature (° C.) | | | | Properties | |
| | Heating conditions | | | Resistance value (Ω) | | Central portion | | End | End | Tensile | Tensile |
| Sample | Heating | Untreated | | Average | Fluctuation | Average | Fluctuation | portion | portion | strength | modulus |
| No. | scheme | fiber bundle | Electrodes | value | width | value | width | (P1) | (P2) | (GPa) | (GPa) |
| 1 | Electric | α | I | 3.6 | −0.2 ~ +0.4 | 1419 | −39 ~ +48 | −41 | −32 | 2.5 | 222 |
| 2 | resistance | β | | 3.7 | −0.2 ~ +0.4 | 1398 | −74 ~ +71 | −85 | −78 | 1.7 | 202 |
| C1 | heating | α | II | 4.7 | −0.4 ~ +1.0 | 1416 | −76 ~ +97 | −329 | −143 | <1.4 | <170 |

| | | | | | | | |
|---|---|---|---|---|---|---|---|
| D1 | Furnace | α | — | — | — | 1.4 | 173 |
| D2 | heating | β | | | | 1.4 | 191 |

### DESCRIPTION OF REFERENCE NUMERALS

11, 12 Rollers (Electrodes)
115 Trench
1151 Bottom portion (Converging Aggregating structure)
2 Power source
3 Control unit (Control device)
4 Radiation thermometer
Bobbin (Conveying device)
6 Tensioner
7 Idler
8 Chamber
M1, M2 Fiber bundle heating apparatus
F1 Untreated fiber bundle
Fh Electric resistance heating fiber bundle
F2 Treated fiber bundle

1. A method comprising:
moving a fiber bundle to length direction so that conductive surface of the fiber bundle is in contact with at least a pair of electrodes; and
heating the fiber bundle by applying a voltage between at least a pair of electrodes;
wherein at least either electrode in the pair of electrodes has an aggregating structure that aggregates the fiber bundle while being in contact with an outer surface of the fiber bundle.

2. The method of claim 1, wherein the aggregating structure is either cylindrical-shaped or a trench with a decreasing width to depth direction.

3. The method of claim 1, wherein the electrode having the aggregating structure is a rotating body,
the aggregating structure is a trench located in outer surface of the rotating body and width of the trench decreases to rotational axis direction of the rotating body.

4. The method of claim 3, wherein the trench has a sloping part in outer surface side.

5. The method of claim 1, wherein the fiber bundle includes at least either a stabilized fiber, an infusibilized fiber or a pre-carbonized fiber.

6. An apparatus comprising:
at least a pair of electrodes;
a conveying device configured to move a fiber bundle suspended between the pair of electrodes, to length direction of the fiber bundle; and
a power source configured to supply electrical power to the pair of electrodes;
wherein at least either electrode in the pair of electrodes has an aggregating structure that aggregates the fiber bundle while being in contact with an outer surface of the fiber bundle.
